(19) United States
(12) Patent Application Publication
(10) Pub. No.: US 2009/0245254 A1
(43) Pub. Date: Oct. 1, 2009

(54) COMMUNICATION SYSTEM

(75) Inventor: Tadahisa Ohno, Tokyo (JP)

Correspondence Address: DARBY & DARBY P.C., P.O. BOX 770, Church Street Station, New York, NY, 10008-0770, US

(73) Assignee: Yamatake Corporation, Tokyo (JP)

(21) Appl. No.: 12/410,663

(22) Filed: Mar. 25, 2009

(30) Foreign Application Priority Data
Mar. 31, 2008 (JP) 2008-93601

(51) Int. Cl. H04L 12/56

(52) U.S. Cl. 370/390

(57) ABSTRACT

To provide a communications system capable of resolving dropped data by achieving retransmission control without increasing the communications load, such as with ACK. Measurement data received by a transmitting station is stored in the form of a ring buffer after the assignment of a data number for each specific number of measurement data so as to enable the transmission as a packet, the packet is transmitted through one-way multicast communications to a receiving station, and when the existence of a dropped packet is detected by a receiving station that has received the transmission, a retransmission request is sent by retransmission requesting means to the transmitting station from the receiving station, and the transmitting station transmits to the receiving station, as a packet, the applicable data number and all of the measurement data for that data number.

### CROSS REFERENCE TO PRIOR APPLICATIONS

The present application claims priority under U.S.C. §119 to Japanese Patent Application No. 2008-93601, filed Mar. 31, 2008. The content of the application is incorporated herein by reference in its entirety.

### FIELD OF TECHNOLOGY

The present invention relates to a communications system capable of resolving dropped data by achieving retransmission control without increasing the communications overhead.

### BACKGROUND OF THE INVENTION

Controlling devices such as temperature adjusting devices or measuring devices and PLCs are connected through a network to monitoring devices (PCs, servers, or the like, to perform time series data transmission. This type of data transmission communicates state quantities of various types of processes, and a variety of approaches is used. For example, when transmitting data measured by a measuring instrument to another device, the use a connection-type communications protocol such as TCP/IP enables transmission so to prevent dropped data. Here transmission packets (which include measurement data over a specific time period) are assigned numbers, and those packets for which no ACK (ACKnowledge—a reception confirmation) is received, are retransmitted from the transmission side, to enable reception without omissions.

owever, this type of technology has problems such as the following. One is that when the measurement data is rapidly produced by the measuring instrument while in a state wherein the ACK has not been returned by the receiving side and wherein the measuring device side cannot provide large memory resources then the amount of data for which transmission has not been completed will increase in the same manner on the transmitting side (or the measuring instrument) and eventually the memory becomes full with that type of data.

A mechanism such as described above is necessary when it is necessary to send measurement data to the receiving side; however, when there is data wherein some degree of time elapses (such as “real-time data,” or the like), there is a problem in that the newest data transmission will be lost because of the retransmission of the old data. That is, there are cases where it is not necessarily good to store data when time has elapsed. Another problem is that when a plurality of devices are to receive the measurement data, then it is necessary to make multiple connections, which may place a greater strain on memory resources, and, at the same time, there is the need for multiple packets in simultaneous data transmissions.

For example, in a network system, a multicast receiving table is provided in a communications interface that is compatible with an Ethernet, where multicast addresses that are assigned to frames that can be received (that is, frames wherein data must be used locally are transmitted) are stored in the receiving table.

In the communications interface, a frame that is received in a multicast is first accepted by the communications interface, and a determination is made as to whether or not the multicast address of the received frame is recorded in the multicast receiving table, and if recorded, then the received frame is sent to the MPU or the RAM, but those frames for which the multicast address is not recorded in the multicast receiving table are discarded by the communications interface.

Consequently, when there are three data, namely virtual memory address 1, virtual memory address 2, and virtual at memory address 3, that are stored in a node (1) to be sent, then the three transmission frames of the multicast address “MA1-1,” “MA1-2,” and “MA1-3,” are sent sequentially from the node (1) to the network cable. At this time, the switching buffer that receives each of the transmission frames sends those transmission frames to all of the nodes that are subscribed to the network, because the frames were transmitted using multicasting.

Consequently, while a node (2) receives all of the transmission frames that were sent by multicasting from the node (1), because “MA1-1, and “MA1-2” are recorded in the multicast receiving table of the communications unit of the node (2), and “MA1-3” is not recorded, the communications interface sends the two received frames to the MPU and RAM, but discards the frame for “MA1-3” that was not recorded. That is, there is a known device wherein, for the nodes on the receiving side, a determination that only the frames that are required by the receiving side are proper frames is made by the communications interface, so specific processes are performed, but those frames that are not required are discarded by the communications interface side, so as to reduce the load on each of the nodes. (See Japanese Unexamined Patent Application Publication 2006-217580 (Page 10, FIGS. 5 and 6 (“JP '580”))

However, JP '580, referenced above, basically describes discarding communications from unnecessary address nodes using multicast communications, and while there is a statement that “the receiving side receives into the node only the data required by the receiving side,” a determination is made as to whether or not the address of the data that is required by the receiving side exists in the multicast addresses of the table, and if not, then all is discarded.

Additionally, while there is a reference to “dividing the data that requires synchronicity into multiple frames and transmitting,” taking into consideration dropped data during the timing of a single transmission, this process merely solves the problem of data coherency, but provides no solution at all to the omission of an entire packet. Furthermore, while there is a reference to the effect that there are queries from the receiving side to the transmitting side, these queries are only for merely acquiring suitable addresses.

Additionally, data transmissions today are mainly multicast communications, and in multicast communications that emphasize reliability it is necessary to provide retransmission control during the same interval in order to cause the retransmission of data that has been dropped. Multicast communications are for distributing data efficiently to a plurality of communications partners, and are sent to a “specific” large number of partners.

However, because in multicast communications there are a large number of data recipients, it is not possible to engage in two-way exchange, so this is not suited to applications requiring reliability in the communications. Additionally, in the so-called TCP/IP two-way communications, there is the problem that the communications overhead would be large. Furthermore, when using ACK as the retransmit control within the same interval, there is the problem that the ACKs that are sent from a plurality of receiving sides converge on the transmitting side, causing the problem of an “ACK-implosion”.

The object of the present invention is to use one-way multicast communications to transmit, after the assignment of sequence numbers to process state quantities, from the control equipment that is the transmitting station. Additionally, at the monitoring equipment that is the receiving station, the process state quantities that are successfully received are received, and dropped data is detected by dropped sequence numbers at that time, enabling a retransmit request. As a result, it is possible to achieve the retransmit control without increasing the communications overhead, such as with the ACK, in order to provide a communications system capable of eliminating data omissions.

### SUMMARY OF THE INVENTION

A communications system as set forth in claim 1 of the present invention is a communications system for performing multicast communications from a transmitting station node/nodes to a plurality of receiving station nodes, wherein one or more transmitting stations and a plurality of receiving stations are connected via a specific network so as to be able to communicate, and wherein the transmitting station/stations and the receiving stations each have nodes including controlling means for controlling the respective transmitting station/stations and receiving stations, and communications interfaces, wherein a transmitting station includes a state quantity acquiring means for acquiring measurement data measured at specific control intervals;

transmission storing means for storing sequentially, in a specific number of buffers that are assigned data numbers, measurement data acquired by the state quantity acquiring means transmitting means for reading out the buffer data of buffers for each data number assigned to a specific number of measurement data stored in the transmission storing means, and for performing multicast transmission to the network through the controlling means and the communications interface; and

retransmission means for reading out, from the transmission storing means, a buffer data related to a data number for which a retransmission request has been made from the receiving station, for transmitting to the receiving station that has made the retransmission request, through the node and the network, when reading out is possible, or ignoring the retransmission request if reading out, from the transmission storing means, is not possible for the buffer data related to the data number for which the retransmission request was made;

and wherein the receiving station comprises:

receiving means for receiving a buffer data related to a data number through the network and the node;

reception storing means for storing sequentially, in the data number sequence, buffers data relating to data numbers received by the receiving means; and

retransmission requesting means for detecting whether or not a data number stored in the reception storing means has dropped data, and, if it is determined that there is dropped data, transmitting a retransmission request, including the data number, to the transmitting station through the controlling means and the communications interface.

Given the communications system above having a structure such as this, no confirmations are made by the transmitting station as to whether or not the receiving station has received the packet, and the receiving station performing a retransmit request for the packets that could not be received makes it possible to not only prevent dropped data, but also to send data in a time series to a plurality of receiving stations.

The communications system of the present invention is a communications system wherein the transmission storing means are a ring buffer for sequential storing wherein old data numbers are overwritten with the newest data numbers and the measurement data thereof are overwritten in the buffer memory when the number of data numbers reaches a specific number that has been set in advance.

The communications system as set forth in the present invention wherein the transmitting station performs the retransmission means when the buffer pertaining to the data number with dropped data in the retransmission request exists in the ring buffer of the transmission storing means; and ignores the retransmission request when the buffer does not exist in the ring buffer.

The communications systems set forth above having this type of structure enables a reduction in the processing overhead of the transmitting station by reducing the probability that reception data will be dropped, and by increasing the number of ring buffers when setting up the number of ring buffers depending on the use environment.

The present invention is a communications system wherein the data number is incremented with each full measurement data relating to that data number, where the numeric value of the data number as an upper limit value, where if that upper limit value is exceeded, the data number numeric value is reset to 0, where that upper limit value is greater than the number of buffers stored in the ring memory.

The communication system as set forth above makes it possible to prevent dropped data within the range of the ring buffer when using this type of configuration.

The present invention enables the provision of a communications system capable of preventing dropped data within the scope of a ring buffer through the establishment of a limitation on the retransmission process, through setting a limit count for which the retransmitting process can be performed so as to limit the measurement data of a specific count, relative to data numbers of that count, to data numbers that are in a ring buffer comprising stored buffers, because processing all retransmit requests would increase the load on the transmitting station.

### BRIEF DESCRIPTION OF THE DRAWINGS

FIG. 1 is a block structural diagram of a communications system according to the present invention.

FIG. 2 is an explanatory diagram illustrating a data structure according to an example of embodiment according to the present invention.

FIG. 3 is a flowchart for explaining the distinctive functions of the communications system in the example of embodiment according to the present invention.

### DETAILED DESCRIPTION OF THE INVENTION

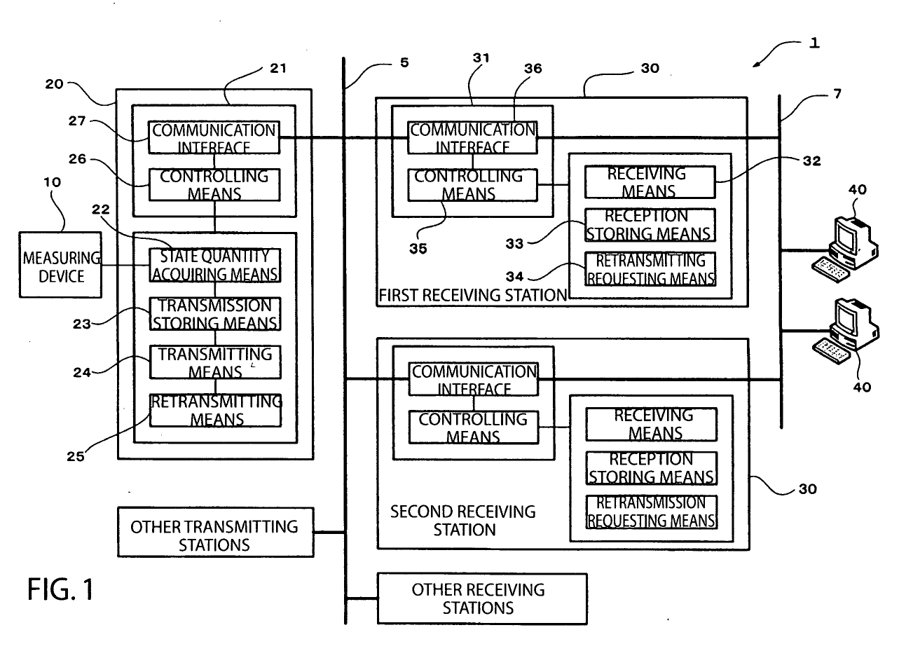

A communications system according to an example of embodiment according to the present invention will be described below based on the drawings. FIG. 1 is a block structural diagram of a communications system 1 according to an example of embodiment according to the present invention, where a higher-level computer 40 and a receiving station 30 made from a server, or the like, are connected by a network 7, and the receiving station 30 and a transmitting station 20 to which various measuring instruments are attached is connected to a hardwired or wireless LAN 5.

Here the an explanation will be given in detail regarding a plurality of receiving stations 30 and a transmitting station 20 that is connected to a measuring instrument, such as a sensor or a flow meter, or the like, to receive the measurement data. Note that the measuring instrument itself may be the transmitting station, in which case the functions possessed by a transmitting station are possessed by the measuring instrument. Note that the communications to the receiving station 30 from the transmitting station 20 are one-way multicast communications, and, at the beginning of the data, an IP address for identifying the transmission destination group, known as a multicast address, is provided before transmission. When this is done, a router (not shown) that exists in the communications path creates copies of the data to be sent, depending on the circumstances, and delivers the copies to the plurality of partners that have been set in advance, and thus the transmitting side is free and does not have to send large amounts of data, making it possible to reduce the network overhead that would be caused by transmitting unnecessary packets.

The transmitting station 20 comprises state quantity acquiring means 22 for acquiring measurement data, made from, for example, a communications device; transmission storing means 23 for storing the acquired data; transmitting means 24 for transmitting data to the receiving station 30; and structured from, as a node 21, controlling means 26 having a CPU or MPU and a memory such as a ROM or a RAM, or the like, and a communications interface 27 for performing networks communications with a LAN 5 or a higher-level computer 40. Note that the communications interface 27 here performs primarily multicast transmissions to the receiving stations 30.

The state quantity acquiring means 22 acquire measurement data from the measuring device 10 that is connected to the transmitting station 20. These state quantity acquiring means 22 acquire, as measurement data, state quantities based on a process time sequence sent from the measuring device 10 with each specific control time interval, which has been set in advance.

The transmission storing means 23 partition the measurement data that have been acquired by the state quantity acquiring means 22, described above, by, for example, transmission intervals of every several seconds or every several minutes, and store them in a single buffer after adding a single data number, as a time series sequence number, to these multiple measurement data. For the number of buffers that comprise the transmission storing means 23, N is the setting value for the number that can be stored within a specific time period.

The transmitting means 24 send the measurement data, which has been stored in the transmission storing means 23, towards the receiving stations 30 through the communications interface 27, and when the measurement data are sent, a determination is performed as to whether or not a buffer corresponding to the data number has been formed, and if a buffer corresponding to the data number has been formed, then the transmission towards the receiving station 30 is performed.

The retransmitting means 25 are that which take, from the transmission storing means 23, the measurement data for which a transmission request has been made, and send it through the communications interface 27 when there has been a retransmission request from the receiving station 30. The number of buffers stored in the transmission storing means 23, as described above, is N within a specific time period, and if the retransmission request is sent after that specific time period has elapsed, then that data number will have been deleted from the buffer, and thus will not exist.

The receiving station 30 is, preferably, a data server made from: a personal computer, and is structured from receiving means 32 for receiving measurement data from the transmitting station 20; reception storing means 33 for storing measurement data that has been received; and retransmission requesting means 34 for requesting, to the transmitting station 20, a retransmission if there is measurement data that could not be received; along with controlling means 35 and a communications interface 36, as with the transmitting station 30 described above.

The receiving means 32 are that which receive, as measurement data for each data number, packets that are sent from the transmitting station 20 through the communications interface 36. The measurement data for each data number received is stored in the reception storing means 33.

In the reception storing means 33, the measurement data that has been received is stored for each of the assigned data numbers. These reception storing means 33 are structured so as to store only the number of buffers for a specific count of data numbers that is determined in advance, structured in a so-called ring buffer approach wherein when, for example, only five data numbers can be stored, the new data is stored while sequentially erasing the old data.

The retransmission requesting means 34 detect whether or not a number has been dropped in the data numbers based on the data numbers that are stored in the reception storing means 33, and if data has been dropped, then requests, to the transmitting station 20, that all of the measurement data of that data number be retransmitted.

Note that while only a single measuring device 10 is shown for the transmitting station 20 in FIG. 1, a plurality of measuring devices 10 may be connected to a single transmitting station 20, and a plurality of transmitting stations 20 and a plurality of receiving stations 30 may be connected to the LAN 5.

Additionally, in the communications system 1 set forth above, it is assumed that the node address for the multicasting has been defined in advance. Furthermore, as will be described below, as an example of the structure of a buffer corresponding to the data numbers, a plurality of individual measurement data {PV1, PV2, . . . ,}, which are stored sequentially into the buffer memory following the data number and a colon. The size of the buffer memory may be either static or variable. Additionally, the minimum structure, in the case wherein there is only a single PV in the transmitting station 20, is “1:1,” for the data number: PV. Furthermore, a while in the communications system 1 the data acquired by the transmitting station was described as measurement data, there is no particular limitation on the type of data, such as a control log or timestamp data.

In the communications system 1 set forth above, the transmitting station 20 provides all buffers corresponding to the data numbers which comprise a plurality of buffers, and the receiving station 30 is structured so as to receive and set up its own buffers. Furthermore, the size of the buffers is not necessarily the same in the transmitting station and the receiving stations. The situation wherein data is sent and received between the transmitting station 20 and the receiving station 30 will be explained next.

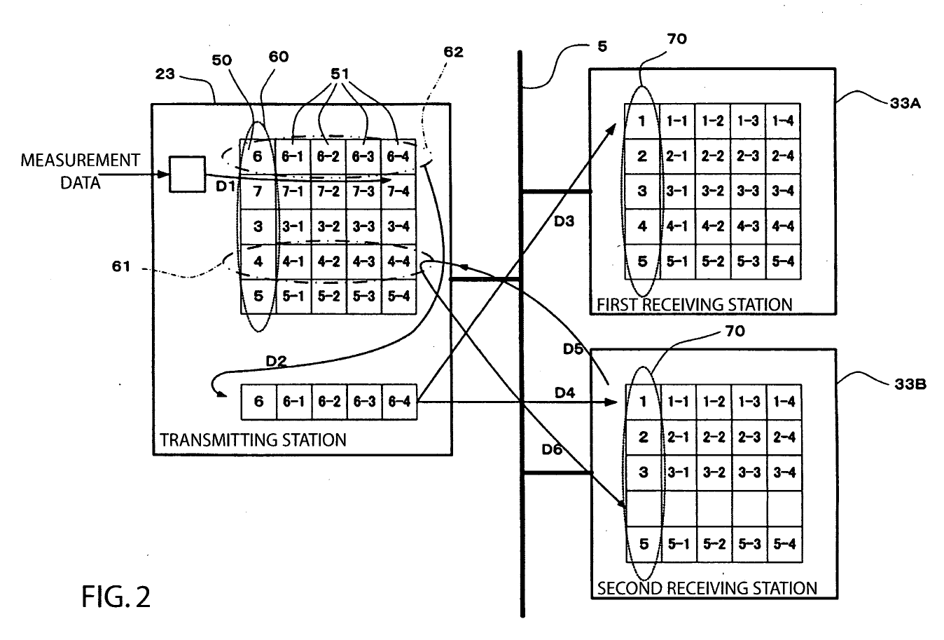

FIG. 2 is an explanatory diagram for explaining the structure of the various buffers between the two receiving stations 30A and 30B and the transmitting station 20 that is connected to the LAN 5 so as to be able to communicate. In the measurement data set forth above, N data numbers, structured from a plurality of buffers, along with buffers 61, 62, . . . (where there are five buffers in this case), corresponding to those data numbers, are established in the transmission storing means 23 of the transmitting station 20, where the buffer memory 51 (the measurement data—from 6-1 through 6-4) thereof are stored with a data number 50 that is assigned in accordance with the packet size that has been set in advance, for each buffer 61, 62, . . . corresponding to that data number. That is, looking at the buffer 61 corresponding to the data number 4, assuming one packet to be the data number and four measurement data, then the buffer memory content of “4-1” through “4-4” will be set as the buffer 61 corresponding to a single data number for the data number “4”.

Additionally, this data number 50 is assigned with one data number 50 for a plurality of buffers, and is stored, to form the data number set 60. Given this, a ring buffer is formed wherein the buffers 61, 62, . . . corresponding to a data number for which a specific amount of time has elapsed will be deleted and, in its place, measurement data to which a new data number 50 is assigned will be stored. In the example in FIG. 2, the data number “1” has already been deleted, the data number “6” has been stored, and the data number “2” will similarly be deleted, and the data number “7” will be stored.

The measurement data that has been received, or in other words, the buffers 61, 62, . . . , corresponding to the data number 50, which is the packet that has been set up by the transmitting station 20, will be accumulated and stored in the reception storing means 33 of the receiving station 30 based on a specific rule, such as in the increasing order or decreasing order of data numbers 50. The buffers 61, 62, . . . , corresponding to a data number that has been sent from the transmitting station 20 are all stored in reception storing means 33 of a first receiving station 30A.

However, data numbers “1” through “3” are stored in the reception storing means 33 of a second receiving station 30B, and data number “4” has been dropped, but the next data number “5” is received and stored. In other words, it is necessary to perform a retransmission request for the data number “4”.

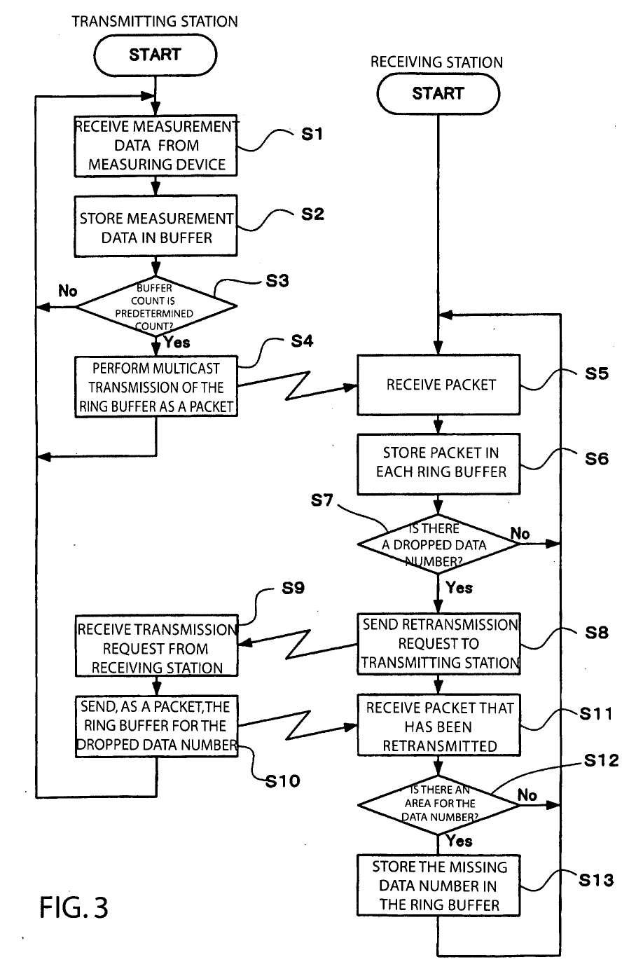

FIG. 3 is a flowchart illustrating the state of data communications performed between the transmitting station 20 and the receiving station 30 in the communications system according to the present invention. Here the explanation will include that which is related to the data structures of the transmitting station and the receiving station illustrated in FIG. 2.

The transmitting station 20 acquires measurement data that is sent from the measuring device 10 through the state quantity acquiring means 22 (Step S1). The acquired measurement data is stored in a sequential buffer as illustrated by D1 in FIG. 2 (Step S2). One packet is structured from the data number 50 and four buffer memories 61. When a buffer 62 is formed corresponding to a single data number, then a buffer for a new data number 50 is structured (where, for example, the next data number “7” is formed after data number “6”).

Following this, a determination is made by the transmitting means 24 as to whether or not measurement data has been stored in each of the buffer memories 51, being, for example, four buffer memories 51 (Step S3). If the buffer 62 corresponding to the data number has not been formed, then the processes of Step S1 and Step S2 are repeated. If the buffer 62 corresponding to the data number has been formed, then, as illustrated by D2 in FIG. 2, the buffer 62 corresponding to that data number, as a packet, is received by the communications interface 27 through the controlling means 26 from the transmitting means 24 and sent to a plurality of receiving stations 30 (the first receiving station 30A and the second receiving station 30B) through multicasting communications (Step S4). Then the transmitting station 20 goes into a standby state until the arrival of the next measurement data that is sent, after which processing returns to step S1.

The packet that is sent from the transmitting station 20 in Step S4 is received by the communications interface 36 of each of a plurality of receiving stations 20, and passed through the controlling means 35 to the receiving means 32 (Step S5). The receiving means 32, as illustrated in D3 and D4 of FIG. 2, store the received packet in the reception storing means 33 (Step S6).

Then a determination is made as to whether or not the data number 70 that has been stored in the reception storing means 33 was stored in an order that has been set in advance (Step S7). In other words, when the data number 70 is a continuous number, it is determined that “4” of data number 70 of the reception storing means 33 that are provided in the second receiving station 30B illustrated in FIG. 2 has been dropped. If there is no dropped data in data number 70, then the standby process of Step S5 is performed.

If it is determined that there has been dropped data, then retransmission request data indicating that “4” in the data number 70 has not yet been received is sent to the transmitting station 20 by the retransmission requesting means 34 through the controlling means 35 by the communications interface 36 (Step S8). Then the transmitting station 20 goes into a standby state and the processing returns to Step S1.

When the transmitting station 20 receives the data indicating that the packet for “4” of data number 70 has not yet been received (Step S9), then the buffer 61, corresponding to data number “4” of data number 50 is retrieved from the transmission storing means 23 by the retransmitting means 25 (illustrated by D5 in FIG. 2). This is then passed as a packet to the communications interface 27 through the controlling means 26, and sent to the second receiving station 30B (Step S10).

The packet that has been retransmitted is received by the receiving means 32 of the second receiving station 30B through the communications interface 36 and the controlling means 35 (Step S11). A determination is performed as to whether or not there is an area for storing the data number of the packet that has been retransmitted (Step S12), and if all of the buffers for the data numbers other than that which has been retransmitted already arrives at a specific number for the reception storing means 33, then processing returns to Step S5 without storing the data number. If the specific number for the reception storing means 33 is not reached, then, as illustrated in D6 in FIG. 2, the data is stored as data number “4”, which had been dropped, in the reception storing means 33 by the receiving means 32 (Step S13). Then a standby state is entered until the reception of the next packet, and processing returns to Step S5.

In this way, in the transmitting station 20, buffers 61, 62, . . . , corresponding to the data numbers that are structured from a plurality of buffer memories 51 are established, and measurement data is stored in a single buffer memory 51. The data number is incremented each time a new buffer is written. However, there is, of course, an upper limit value, and when the upper limit value is exceeded, then the data number is reset to 0. Each time the transmitting station 20 becomes full with a number of buffer memories 51 that has been established in advance, then a data number and the buffer are formed as a packet, which is sent to the plurality of receiving stations 30 through a multicast transmission. At this time, a connection-type communications protocol is not used, and so no ACK is required, as it has been in the past.

That is, it is possible to transmit using multicast transmission to the plurality of receiving stations 30. The receiving stations 30 store, in data number sequence, the packets received from the transmitting station 20, to reproduce the time series data. Furthermore, if it is discovered that a data number has been dropped, then notification of that data number is made to the transmitting station, and if the dropped data is across a count of all of the buffers corresponding to a data number of a count determined in advance, then a retransmission request is made for the measurement data of that data number, making it possible to prevent dropped receptions.

Furthermore, by storing all of the measurement data by the transmitting station unit on the higher-level computer that is connected to the network, it becomes possible to perform data processing so as to enable visual confirmation of the state of control by the daily unit, weekly unit, or monthly unit.

We claim:

1. A communications system performing multicast communications from a transmitting station node/nodes to a plurality of receiving station nodes, wherein one or more transmitting stations and a plurality of receiving stations are connected via a specific network so as to be able to communicate, and wherein the transmitting controllers controlling the respective transmitting station/stations and receiving stations, and communications interfaces, wherein a transmitting station comprises:
a state quantity acquiring device acquiring measurement data measured at specific control intervals;
a transmission storing device storing sequentially, in a specific number of buffers that are assigned data numbers, measurement data acquired by the state quantity acquiring device;
a transmitting device reading out the buffer data of the buffers for each data number assigned to a specific number of measurement data stored in the transmission storing device, and for performing multicast transmission to the network through the controller and the communications interface; and
a retransmission device reading out, from the transmission storing device, a buffer data related to a data number for which a retransmission request has been made from the receiving station, transmitting to the receiving station that has made the retransmission request, through the node and the network, when reading out is possible, or ignoring the retransmission request if reading out, from the transmission storing device, is not possible for the buffer data related to the data number for which the retransmission request was made;
and wherein the receiving station comprises:
a receiver receiving a buffer data related to a data number through the network and the node;
a reception storing device storing sequentially, in the data number sequence, buffers data relating to data numbers received by the receiver; and
a retransmission requesting device detecting whether or not a data number stored in the reception storing device has dropped data, and, if it is determined that there is dropped data, transmitting a retransmission request, including the data number, to the transmitting station through the controller and the communications interface.

2. The communications system as set forth in claim 1, wherein:
the transmission storing device is a ring buffer for sequential storing wherein old data numbers are overwritten with the newest data numbers and the measurement data thereof are overwritten in the buffer memory when the number of data numbers reaches a specific number set in advance.

3. The communication system as set forth in claim 2, wherein:
the transmitting station performs the retransmission device when the buffer pertaining to the data number with dropped data in the retransmission request exists in the ring buffer of the transmission storing device; and ignores the retransmission request when the buffer does not exist in the ring buffer.

4. The communications system as set forth in claim 1 wherein the data number is incremented with each full measurement data relating to that data number, where the numeric value of the data number as an upper limit value, where if that upper limit value is exceeded, the data number numeric value is reset to 0, where that upper limit value is greater than the number of buffers stored in the ring memory.

5. A method for performing multicast communications from a transmitting station node to a plurality of receiving station nodes, wherein one or more transmitting stations and a plurality of receiving stations are connected via a specific network so as to be able to communicate, and wherein the transmitting station and the receiving stations each have nodes comprising controllers controlling the respective transmitting stations and receiving stations, and communications interfaces, comprising the steps of:
at the transmitting station, receiving measurement data from a measuring device;
at the transmitting station, storing measurement data in a first ring buffer;
at the transmitting station, determining a buffer count meets a predetermined count;
at the transmitting station, transmitting a multicast transmission of the first ring buffer as a packet;
at the receiving station, receiving the packet;
at the receiving station, storing the packet in a second ring buffer;
at the receiving station, determining a dropped data number;
at the receiving station, sending a retransmission request to the transmitting station;
at the transmitting station, receiving the retransmission request from the receiving station;
at the transmitting station, sending, as a packet, the ring buffer for the dropped data number;
at the receiving station, receiving packet that has been retransmitted;
at the receiving station, determining an area for the data number; and
at the receiving station, storing the missing data number in the second ring buffer.
